(19) United States
(12) Patent Application Publication
(10) Pub. No.: US 2004/0211631 A1
(43) Pub. Date: Oct. 28, 2004

(54) Hydraulic damper

(76) Inventor: William W. Hsu, Tehachapi, CA (US)

Correspondence Address: Lesley A. Hamlin, Textron Systems Corporation, 201 Lowell Street, Wilmington, MA, 01887, US

(21) Appl. No.: 10/422,374

(22) Filed: Apr. 24, 2003

(51) Int. Cl. F16F 9/00; F16F 9/48

(52) U.S. Cl. 188/284; 188/286; 188/322.19

(57) ABSTRACT

A cylinder and piston assembly having damping orifices disposed on a wall of the cylinder is used for impact energy and force reduction. The damping orifices may be of any shape and, therefore, a cylinder and piston may produce variable damping forces and variable resistive forces. A damping orifice may be positioned at any point or location along the length of the cylinder bore. The damping coefficient of the system begins to change at the location of a damping orifice in the cylinder bore. A desired system response, e.g., progressive, regressive, varying, or any combination thereof, etc., may be advantageously obtained by designing the damping orifices to produce falling-rate and/or rising-rate damping coefficients.

### BACKGROUND

Mechanical and hydraulic force absorption systems, also known as “shock absorbers,” are known in the art. Such force absorption systems commonly counteract externally applied forces by producing resistive forces that are proportional to a displacement, or a velocity, or both, of a component within the particular force absorption system. These types of systems are hereinafter referred to as displacement-based, velocity-based, and combined force absorption systems, respectively.

For each type of force absorption system, the amount of energy that is absorbed by the system when a force is applied is one measure of the effectiveness of the system for absorbing force. Generally, the absorbed energy is equal to the amount of work performed by the moving components of the particular system in response to the applied force. This amount of work is equal to the product of the distance that one or more components of the system are forced to travel, multiplied by the force that is required to move the one or more system components. In the case of a variable force, the work performed by the system is the integral of the force taken over the distance of travel of the one or more moving components.

A common spring is an example of a displacement-based force absorption system. The resistive force produced by a spring is typically proportional to the distance the spring is compressed or stretched. The resistive force produced is proportional to the spring or structural stiffness and the displacement of one portion of the spring with respect to a fixed portion of the spring. Air and other fluids, including hydraulic fluid, may be used in a displacement-based damping system as another type of spring, i.e., a fluidic spring. For such fluidic springs, resistive forces are commonly produced when a piston or plunger is forced against a fixed amount of compressed fluid contained in an enclosed volume, e.g., a cylinder in a cylinder and piston assembly.

Springs tend to contribute to oscillatory motion in the mechanical systems in which they are used. In many situations, oscillatory motion is undesirable because at certain frequencies of oscillation, very small forces applied to the mechanical system can produce large movements within the system. Oscillatory motion is a particular concern at the natural frequency of a mechanical system, which is defined by the square root of the quotient of the spring stiffness divided by the mass of the particular mechanical system.

A viscous damper is an example of a velocity-based force absorption system that produces a resistive force that is proportional to the velocity of a moving component of the system. A hydraulic cylinder and piston assembly, in which a piston fits within a cylinder and is forced to move along the cylinder by pressure differences in a fluid on either side of the piston, may act as a viscous damper. The resistive force provided by such a system is related to the viscous damping or “damping coefficient” and the fluid compressibility or fluid stiffness. A hydraulic cylinder and piston assembly acting as a viscous damper may also be part of a hydraulic actuator that is controlled by a hydraulic control valve, e.g., an electro-hydraulic servovalve.

Viscous dampers are used in many different automotive and aerospace applications. Virtually all of these applications share a common characteristic that the viscous damper has a constant damping coefficient that is not adjustable over a wide continuous range. Some prior viscous damping systems have been adjustable to a limited degree by having an external adjustable metering orifice. These types of systems typically employ a disk having multiple metering orifices, each with a different diameter, arranged on the disk. As the disk is adjusted or turned by a user, the different metering orifices are placed in and restrict the flow of a hydraulic circuit of the system, thereby causing discrete changes to the constant damping coefficient of the force absorption system. As a result of this configuration, these viscous damping systems are relatively bulky and expensive because of the external metering orifices and related structure. Furthermore, such systems do not have the capability for providing a nonlinear response in the absence of some means external to the hydraulic circuit, e.g., a nonlinear mechanical linkage. External mechanical linkages increase cost and complexity of the systems in which they are used, and are difficult to retrofit to machines and vehicles already having force absorption systems.

A viscous damper having a damping coefficient with a limited nonlinear range is known to have been used in the landing systems of certain military aircraft. This type of landing system includes a cylinder and piston assembly within one or more landing struts of the aircraft. The hydraulic system of the military aircraft includes four small relatively short and relatively narrow orifices in the wall of its hydraulic cylinder. The total stroke or travel of the piston exceeds ten inches and the orifices are located along the last eighth of an inch of the stroke of the piston, at the position of a hydraulic port. In the certain military aircraft system, piston movement from a retract position to an extend position and back again is initiated by a hydraulic circuit. This system exhibits a two-valued damping coefficient that is essentially two different values with an abrupt transition between the two. Such an abrupt transition between damping coefficients indicates a corresponding large change in resistive forces and the initial and final velocities of the piston. Large changes in the velocity of the piston in a short distance, i.e., 0.125 inch, produce large forces that may be unsafe for pilots in the absence of ancillary shock absorption systems. Such ancillary shock absorption systems are costly and are undesirable in many industries including the economically competitive automobile industry.

Combined force absorption systems have attributes of both displacement-based and velocity-based force absorption systems. In response to an applied external force, a combined force absorption system produces a resistive force that is proportional to both a position and a velocity of one or more components of the system. The resistive force produced by such a system is related to the viscous damping, the fluid stiffness and the structural stiffness. The fluid stiffness is inversely proportional to the fluid volume under pressure.

Combined force absorption systems are also more complicated than either of displacement-based or velocity-based force absorption systems alone. One example of a combined force absorption system includes a coil spring linked in series or parallel to a cylinder and piston assembly. Additional examples of combined force absorption systems are disclosed in U.S. Pat. No. 6,109,400, issued Aug. 29, 2002, and U.S. Pat. Publication No. US2003/0019698A1, published Jan. 30, 2003. These combined force absorption systems include springs that tend to produce oscillatory motion, are complicated, and are not easily retrofitted to existing hydraulic actuators and viscous dampers.

In certain situations it may be desirable for a force absorption system to respond to an applied force in a nonlinear way. For example, it might be desired for the resistive force produced by a force absorption system to increase as one or more components of the system move in response to the applied force. Conversely, it might be desired for the resistive force produced by a force absorption system to decrease as one or more components of the system move in response to the applied force. A common approach to obtain a nonlinear response in a force absorption system has been to use electronic feedback from various sensors to adjust a physical characteristic of a given force absorption system by associated analog or digital electronic circuitry. An example of electronic feedback used with a hydraulic damper is a semi-active damper with continuous force control that is disclosed in U.S. Pat. No. 5,862,894, issued Jan. 26, 1999. The semi-active damper is controlled by a control circuit which includes a direct main feedback loop, as well as a secondary force feedback loop. The direct main feedback loop includes an inverse model of the damper to continuously adjust two controlled restriction valves that are external to the damper. The associated electronic circuitry and sensors represent an additional system that can fail and the controlled restriction valves add to the complexity, cost, and size of the semi-active damper. Other approaches for obtaining a desired nonlinear response have been directed to adjusting a constant damping coefficient in a stair-stepped manner or by directly or indirectly altering the stiffness of a spring within the particular force absorption system.

An example of a force absorption system that provides a nonlinear response to an applied force is a nonlinear shock absorber disclosed in U.S. Pat. No. 5,513,730 issued on May 7, 1996. This nonlinear shock absorber includes a housing filled with hydraulic fluid and contains a relatively heavy mass or piston supported by a helical coil spring. During shock absorption fluid flows contra to the piston movement with a corresponding elongation of the helical coil spring causing the coil spring to engage an inner wall of the housing to provide for frictional damping. Due to the necessary clearance around the piston for the helical coil spring and related radial gaps, a hydraulic seal is not maintained between the piston and cylinder. Therefore, the nonlinear shock absorber disclosed in the '730 patent is not practical for use as a cylinder and piston assembly of a hydraulic actuator or hydraulic servomechanism. Furthermore, the nonlinear shock absorber disclosed in the '730 patent is prone to mechanical wear of the helical spring after repeated sliding on the inner wall of the housing and the spring itself may have a negative effect as described above. This system is also not readily adapted to already existing hydraulic actuators.

For the foregoing reasons, there is a need for a mechanically simple, inexpensive system and method of velocity-based force absorption or damping that can include a nonlinear force response to applied forces and that can be easily retrofitted to existing hydraulic actuators and cylinder and piston assemblies.

### SUMMARY OF THE INVENTION

The present invention is directed, in general, to a system and method that satisfies this need for mechanically simple, inexpensive velocity-based force absorption or damping that can include a nonlinear force response to applied forces and that can be easily retrofitted to existing hydraulic actuators and cylinder and piston assemblies. One particular embodiment of the present invention may be used in a vehicle to minimize crash or impact forces experienced during a collision or accident. Embodiments of the present invention may be easily and inexpensively installed in existing viscous dampers, cylinder and piston assemblies and hydraulic actuators.

A first embodiment of the present invention includes a cylinder and piston assembly including a cylinder and a piston slidingly disposed within the cylinder. One or more damping orifices are formed on an inner radial surface of the cylinder. The one or more damping orifices are configured to provide a fluid flow path that varies as the piston travels within the cylinder past the one or more damping orifices. A hydraulic circuit may be included that is operational to supply pressurized hydraulic fluid to the piston.

A second embodiment includes a hydraulic damping system including a cylinder and a piston. The cylinder may have a proximal end, a distal end, a cylinder bore defined by an inner radial surface, and a cylinder length. One or more damping orifices may be formed on the inner radial surface of the cylinder. The piston slides within the cylinder bore and the piston is movable from an extend position to a retract position along the cylinder length by a force external to the hydraulic damping system. The hydraulic damping system absorbs energy associated with a portion of the external force. A hydraulic circuit may also be included that is in fluid communication with the piston. The hydraulic circuit may be operational to supply pressurized hydraulic fluid to the piston and cylinder by a supply line and to receive hydraulic fluid from the cylinder by a return line. The piston forces hydraulic fluid through the one or more damping orifices as the piston moves from the extend position to the retract position.

A third embodiment includes a hydraulic damping system for collision energy absorption including a piston and a cylinder having a cylinder wall and a cylinder diameter. The cylinder has a first end and a second end, and a first port and a second port. At least one damping orifice is formed on the cylinder wall. The at least one damping orifice has an associated area, which may be, for example, in a circumferential cross-section or a radial cross-section relative to a longitudinal axis of the cylinder. The at least one damping orifice has an orifice length, an orifice width, and an orifice depth. The piston slides within the cylinder, and the cylinder may be linked to a vehicle. The piston may slide past the at least one damping orifice in response to a collision, and may also be linked to the vehicle. The at least one damping orifice is configured to provide a fluid flow path such that the associated area varies as the piston travels within said cylinder past the at least one damping orifice. A hydraulic circuit containing hydraulic fluid is connected to the cylinder and absorbs energy developed during a collision involving the vehicle as the piston moves relative to the at least one damping orifice. The hydraulic circuit is operable to supply and receive hydraulic fluid from the first port and the second port. The hydraulic circuit may include a pump to pressurize the hydraulic fluid in the hydraulic circuit. Means for fluid displacement, for example a pressure relief valve or shuttle valve, may also be included. The means for fluid displacement enables the piston to move in the cylinder from a portion of the cylinder not including the at least one damping orifice to a portion of said cylinder including the at least one damping orifice and to displace hydraulic fluid within the hydraulic circuit in response to a collision involving the vehicle. A closed-loop control system may also be included.

The closed-loop control system may include an electronic control unit operable to receive one or more signals from a vehicle and to produce an output control signal. The closed loop control system may also include an electric control valve operable to receive the output control signal. The electric control valve may be in fluid communication with the cylinder and piston and control an extend position of the piston. The electronic control unit may include a sum junction. The sum junction may be operable to receive one or more signals including a speed signal proportional to a speed of the vehicle from a speed sensor, a bias input, and a feedback position signal from a position sensor. The electronic control unit may also include an amplifier operable to receive and amplify the output control signal.

A fourth embodiment includes a method of manufacturing a hydraulic damping system. One or more damping orifices may be formed on a hydraulic cylinder wall of a cylinder and piston assembly. The one or more damping orifices may be configured to provide a fluid flow path such that an associated area varies as the piston travels within the cylinder past the one or more damping orifices. The hydraulic damping system is operable to absorb impact energy applied to the piston by the piston forcing fluid through the one or more flow paths. The cylinder and piston assembly may be connected to a hydraulic circuit that is operable to supply the cylinder and piston assembly with pressurized hydraulic fluid.

The piston may be connected to a first portion of a vehicle and the cylinder to a second portion of the vehicle. The hydraulic cylinder may be pressed around a dummy piston to form the one or more damping orifices, and hydrostatic pressure may be used. One or more wedges having a desired shape of a damping orifice may be attached to the dummy piston. A cylinder and piston assembly having one or more damping orifices disposed on an inner radial wall of the cylinder may be formed by placing a slidable piston in the cylinder after the one or more damping orifices are formed on the cylinder wall.

A fifth embodiment includes a method of absorbing impact energy and force. A piston may be moved along a cylinder bore past one or more damping orifices in response to an applied force. The one or more damping orifices are configured to provide a fluid flow path such that an associated area of the one or more damping orifices varies as the piston travels within the cylinder bore past the one or more damping orifices. Hydraulic fluid is forced through the one or more damping orifices with the piston, and impact energy and force are absorbed. The movement of the piston is damped by a variable resistive force. A final velocity of the piston at a post-impact position may be controlled.

A sixth embodiment includes a method of controlling a servomechanism used to absorb collision energy. The method may include the steps of adjusting a position of a piston of the servomechanism and preventing a retraction of the piston during a collision involving the piston by designing a time constant of the servomechanism to be greater than a time of the collision. The method may also include the step of forcing hydraulic fluid through one or more damping orifices in a cylinder wall of the servomechanism in response to the collision. The step of adjusting may further include a step of receiving one or more signals from a vehicle connected to the servomechanism.

In any of the embodiments, an associated area of each of the damping orifices may vary along the cylinder length. In certain embodiments, a damping coefficient associated with the damping orifices is a nonlinear rising-rate damping coefficient.

### BRIEF DESCRIPTION OF THE DRAWINGS

These and other features, aspects, and advantages of the present invention will become better understood with regard to the following description, appended claims, and accompanying drawings. The drawings are not necessarily to scale, emphasis instead being placed upon illustrating the principles of the present invention. The drawings include the following:

FIG. 1 shows cross-section views, FIG. 1A and FIG. 1B, of different cylinder and piston assemblies having different damping orifice shapes.

FIG. 2 shows a schematic representation of an embodiment of a cylinder and piston assembly in a pre-impact position in FIG. 2A and a post-impact position in FIG. 2B. FIG. 2C shows a cross-section of a cylinder bore of the cylinder of FIGS. 2A and 2B. FIG. 2D shows a cross-section of the view shown in FIG. 2C taken along line 2D-2D.

FIG. 3 shows a schematic representation of an additional embodiment of a damping system including a closed-loop control system in a pre-accident position in FIG. 3A and a post-accident position in FIG. 3B.

FIG. 4 shows a schematic representation of a closed-loop control system according to one embodiment of the present invention.

### DETAILED DESCRIPTION

Examples of features and other details of systems and methods according to the present invention will now be more particularly described with reference to the accompanying drawings and the appended claims. It should be understood that the particular embodiments described are by way of example and not as limitations of the present invention. The principal features and steps of the present invention may be practiced in numerous variations without departing from the spirit and scope of the present invention.

The present invention is directed to impact energy and force absorption, and velocity damping or “snubbing” by the use of damping orifices in an actuator or cylinder and piston assembly. Embodiments of the present invention may be used to absorb impact energies and forces that occur when one object collides with another. Embodiments of the present invention may be used to reduce collision velocities between two or more objects to desirable levels. Preferred embodiments of the present invention may be used in automotive applications to absorb impact energy and mitigate forces developed during collisions involving one or more vehicles.

As used herein, the term “damping orifice” may include reference to a recess or volume formed on or within a wall or inner radial surface of a cylinder of a hydraulic actuator or cylinder and piston assembly. A damping orifice may have an orifice depth, an orifice length, and an orifice width. A damping orifice may have a circumferential cross-section including an area along or concentric with an inner radial surface of a cylinder. A damping orifice may have a radial cross-section in a plane transverse to a longitudinal axis of a cylinder. A damping orifice may have an associated area that acts as an aperture that limits the fluid flow rate through the damping orifice. The associated area may be in the circumferential or radial cross-section or in a plane oblique to either cross-section. The term “orifice depth” as used herein may refer to a dimension of a damping orifice along a radial direction of a cylinder. As used herein, the term “orifice length” may refer to a dimension of a damping orifice that is parallel to a longitudinal axis of a hydraulic cylinder. The term “orifice width” may refer to a dimension of the damping orifice that is (i) along a circumference of a cylinder, and/or (ii) along or parallel to a chord of a circular cross-section of a cylinder. The term “dimension” as used herein includes reference to a spatial extent or distance.

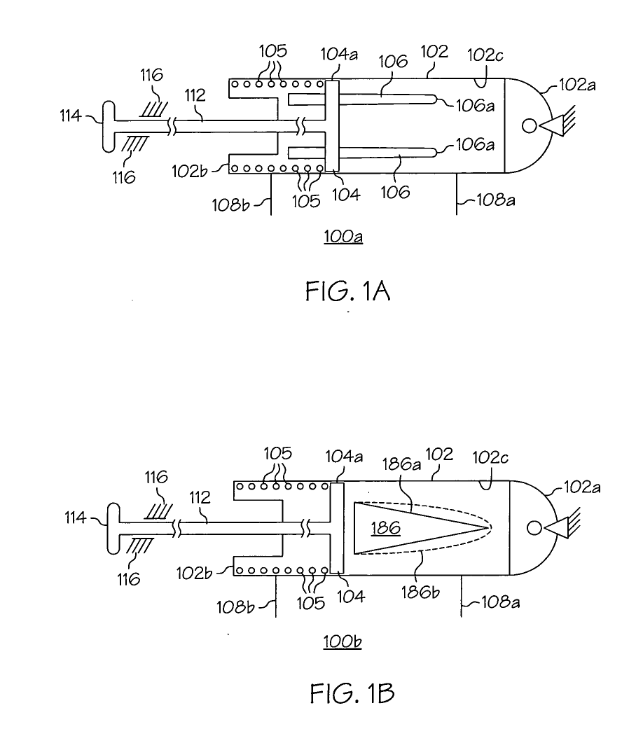

With reference to the figures, different embodiments of the present invention will now be described. FIG. 1 shows cross-section views, FIG. 1A and FIG. 1B, of different cylinder and piston assemblies having damping orifices of different shapes. Each embodiment of the cylinder and piston assemblies shown, 100a and 100b, includes a hydraulic cylinder 102 and a piston 104 that slides within the hydraulic cylinder 102. The cylinder 102 has a proximal cylinder end 102a, a distal cylinder end 102b, and a cylinder bore defined by a cylinder wall or inner radial surface 102c. The piston 104 slides within the cylinder 102 and the cylinder distal end 102b may have one or more seals (not shown) and a piston head to facilitate a hydraulic seal between the piston 104 and the cylinder 102. The piston 104 may have a piston skirt, piston head, or piston sidewall 104a and one or more seals (not shown) may be present, e.g., on the piston sidewall 104a. One or more damping orifices 106, 186 may be disposed along or within the inner radial wall 102c or cylinder wall of the hydraulic cylinder 102. A damping orifice 106, 186 may be positioned at any point or location along the cylinder wall. Each damping orifice 106, 186 has an associated area that is the limiting factor for the fluid flow rate through the damping orifice. The associated area may lie within different cross-sections of its corresponding damping orifice 106, 186, depending on the shape of the damping orifice and the relative position of the piston 104 and the piston sidewall 104a within the cylinder 102. For example, the associated area may be within a circumferential cross-section 106a, 186a on the inner radial wall 102c of the cylinder as shown.

The associated area of each damping orifice 106, 186 may also lie in a radial cross-section of the damping orifice 106, 186. A radial cross-section may include an orifice depth in a radial direction relative to the cylinder 102. The circumferential cross-section may change along the orifice depth. Hydraulic fluid may act on the piston 104 and may be supplied to the cylinder and piston assembly by a hydraulic circuit (not shown). A suitable hydraulic circuit may include hydraulic fluid and apparatus to supply the cylinder and piston assembly with pressurized hydraulic fluid through two or more ports, e.g., 108a, 108b. The ports 108a and 108b may be positioned or configured to supply or receive fluid, e.g., hydraulic fluid, to any point within the cylinder. For example, one port may supply hydraulic fluid at a position within the cylinder on one side of the one or more damping orifices, while another port may receive hydraulic fluid at a position within the cylinder at the opposite side relative to the one or more damping orifices, so that the one or more damping orifices are between the ports.

In FIG. 1A, two damping orifices 106 of unequal lengths are shown. Each damping orifice 106 has a circumferential cross-section 106a that is slightly tapered toward the proximal cylinder end 102a. The associated area of each damping orifice 106 may be different than that of other damping orifices 106, but this is not necessarily so. In FIG. 1B, a damping orifice 186 is shown that has a generally triangular circumferential cross-section 186a. Dashed lines show an alternate damping orifice circumferential cross-section 186b.

With continued reference to FIG. 1, the piston 104 may be connected by appropriate linkage 112 (simplified in the drawings) to an object external to the piston, e.g., a vehicle bumper 114. A spring 105 may be present to bias the position of the piston 104 in a desired direction, e.g., towards the retract position. The spring 105 may be a coil spring and may be located within the cylinder 102 as shown or may be external to the cylinder 102 and connected to the bumper 114 and/or linkage 112. The linkage 112 may be of any suitable kind and may include, but is not limited to, compound mechanical linkages, hydraulic components, elastomers, additional apparatus, or a combination of any of such. A guide 116 may be present to constrain the movement and limit the degrees of freedom of the linkage 112 and any connected object, e.g., a bumper 114. The cylinder and piston assemblies, e.g., 100a, 100b, may be installed on or incorporated within a stationary object or any type of vehicle (not shown). In preferred embodiments, the cylinder and piston assemblies, e.g., 100a, 100b, may be installed or incorporated in an automobile or other vehicle.

The damping orifices 106 may be formed in the cylinder inner radial surface 102c by a cold forming process using a molding tool (not shown) and/or by appropriate machining processes including milling, broaching, and drilling. A suitable molding tool may be constructed from (i) one or more objects that each have a shape corresponding to a desired volume of a damping orifice, and (ii) a surrogate or “dummy” piston. The one or more objects may be joined to the dummy piston, thereby forming the molding tool. The piston of the molding tool is selected to match the size of a piston of a cylinder and piston assembly that is to be used in an embodiment of the present invention. Once created, the molding tool may then be subsequently placed within and pressed into contact with a cylinder 102 used in one embodiment. As a result, an inner radial surface 102c of the cylinder 102 undergoes a controlled deformation. This resulting deformation of the inner radial surface produces damping orifices 106 having a desired shape, i.e., corresponding recesses or “negative images” of the one or more objects on the molding tool. The molding tool is removed from the cylinder 102 and a piston 104 is then placed in the cylinder 102 to form a cylinder and piston assembly according to embodiments of the present invention. In certain embodiments, metal wedges or strips having desired shapes of the damping orifice volumes are brazed onto a dummy piston to produce the molding tool. A steel piston may be used for the molding tool and the cylinder is made of aluminum. These processes may be easily used to retrofit existing cylinder and piston assemblies or hydraulic actuators to include damping orifices for force absorption or damping.

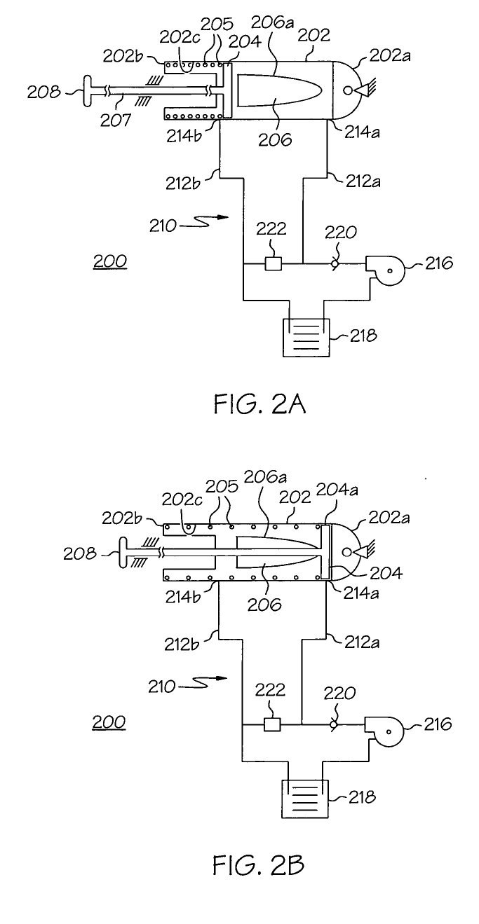

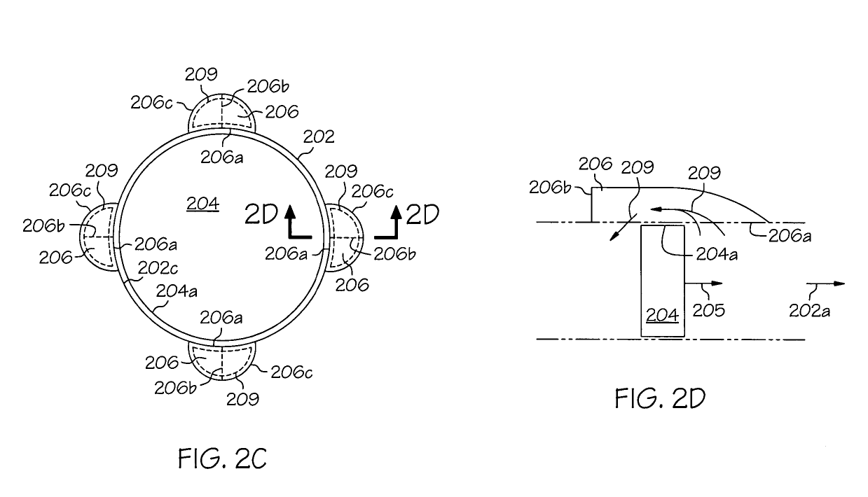

FIG. 2 shows a schematic representation of a velocity-based force absorption or damping system 200 including a cylinder and piston assembly in a pre-impact position in FIG. 2A and a post-impact position in FIG. 2B. A cylinder 202 and piston 204 assembly or actuator is shown, and the cylinder 202 has a fixed proximal end 202a and a distal end 202b. The cylinder 202 has a cylinder bore formed by an inner radial surface 202c, which receives the piston 204. One or more damping orifices 206 are disposed on the inner radial surface 202c (only one damping orifice is shown for the sake of clarity). Each of the damping orifices 206 has an associated area and a circumferential cross-section 206a. The piston 204 may be connected by linkage 207 to an object or machine part 208 that is external to the cylinder and piston assembly, such as a car bumper, a body panel, a structural frame element, or the like. The cylinder 204 may be anchored or connected to any suitable part of a vehicle or object used with the damping system 200, e.g., a vehicle frame member or an engine block. A spring 205 may be present to bias the position of the piston 204 in a desired direction, e.g., towards the retract position.

In FIG. 2A, the piston 204 is shown in an extended position, i.e., the ‘extend’ position, relative to the proximal end 202a of a cylinder 202. The extend position can correspond to a pre-impact or pre-force-absorption state that exists prior to an accident involving a vehicle or object to which the damping system 200 is connected. In FIG. 2B, the piston 204 is shown in a retracted position relative to the cylinder 202, i.e., the ‘retract’ position, which may correspond to a post-impact or post-force-absorption state.

With continued reference to FIG. 2, a hydraulic circuit 210 is present that operates to supply pressurized hydraulic fluid to the one side of the piston 204, e.g., the side toward the proximal cylinder end 202a. Two or more supply and return lines 212a, 212b supply the hydraulic fluid to the cylinder 202 through two or more ports 214a, 214b in the cylinder 202. The hydraulic circuit 210 functions to move the piston 204 within the cylinder 202 to the extend position. The hydraulic circuit 210 may include a pump 216, and the pump 216 may extract hydraulic fluid from a reservoir 218. A check valve 220 may be present in the hydraulic circuit 210 to prevent the hydraulic fluid from being forced backward through the pump 216 during operation of the damping system 200. A pressure relief valve 222 may be present in certain embodiments to facilitate the initial movement of the piston 202 within the cylinder 204. The pressure relief valve 222 may allow the piston 202 to move within the cylinder 204 to a location of the one or more of the damping orifices 206.

The operation of the damping system 200 of FIG. 2 will now be described. The pump 216 may be powered by an appropriate power system, e.g., an electric or fluid power system of a vehicle (not shown), and may pressurize the hydraulic fluid in the hydraulic circuit 210 to an operational pressure. The pump may supply the hydraulic fluid to the cylinder 202 through check valve 220, supply line 212a and return line 212b. This pressurized hydraulic fluid may force the piston 204 to the extend position, which may cause a corresponding displacement of the linkage 207 and object or machine part 208 as shown in FIG. 2A. When the object or machine part 208, e.g., a car bumper, that is linked to the piston is impacted during a collision of sufficient energy and force, the piston 204 is forced to move to a retract position, toward the proximal cylinder end 202a, counter to the force of the hydraulic fluid in the hydraulic circuit 210 as shown in FIG. 2B. In response to the impact energy, the piston 204 slides along the cylinder bore and displaces hydraulic fluid, which is initially forced through the pressure relief valve 222 since the check valve 220 prevents flow back to the pump 216. As the piston 204 is further forced along the cylinder bore by the energy of the impact, the piston 204 reaches the one or more damping orifices 206 on the cylinder wall and the piston sidewall 204a travels within the circumferential cross-section 206a of the one or more damping orifices 206. When the piston 204 is in this position in the cylinder 202, the hydraulic fluid is presented with one or more additional flow paths including the associated areas, around the piston sidewall 204a and through the one or more damping orifices 206 that are formed on the inner radial surface 202c of the cylinder 202. The force exerted or expended by the piston 204 to push the hydraulic fluid through the additional flow paths causes impact energy to be absorbed by the hydraulic fluid as the piston 204 moves along the cylinder 202. The amount and rate of the energy that is absorbed may vary and be controlled by the design of the size of the associated areas of the damping orifices 206. The additional flow paths and movement of the piston 204 in response to impact energy and force are described in greater detail with reference to FIGS. 2C and 2D.

FIG. 2C shows a cross-section of a cylinder bore of the cylinder of FIGS. 2A and 2B. A damping orifice depth 206b and the circumferential cross-section 206a are indicated for each damping orifice 206. Radial cross-sections 206c of the damping orifices 206 are shown. When the piston sidewall 204a travels within the circumferential cross-section 206a of the one or more damping orifices 206, each radial cross-section 206c along with a portion of the corresponding circumferential cross-section 206a corresponds to an additional flow path 209 that includes the associated area through which hydraulic fluid in the cylinder 202 can flow. Due to the additional flow paths 209, the velocity-based resistive force produced by the damping system 200 is variable and depends on the position of the piston 204 and piston sidewall 204a within the cylinder 202 relative to the one or more damping orifices 206.

FIG. 2D shows a cross-section of the view shown in FIG. 2C taken along line 2D-2D. The relative movement of hydraulic fluid as the piston 204 moves towards the proximal cylinder end 202a in response to impact energy is indicated as arrow 205. Hydraulic fluid in front of the piston 204 may flow within one or more flow paths 209 for example as shown, including a flow-limiting associated area, through the damping orifice circumferential cross-section 206a, into the damping orifice 206, and around the piston sidewall 204a. Each flow path 209 around the piston sidewall 204a may include the associated area, which may be proportional to the circumferential cross-section 206a or the radial cross-section 206c of the portion of the damping orifice near the piston sidewall 204a. Because the associated area of each damping orifice may vary, each flow path 209 may change as the piston 204 moves within the cylinder 202. The damping coefficient of the damping system 200 may therefore vary because it is proportional to the associated area and the total flow path of the hydraulic fluid in the system, including any flow paths 209 through the damping orifices 206 and around the piston sidewall 204a. Since the resistive force produced by the damping system 200 is a function of the damping coefficient of the system 200, the resistive force may change as the damping coefficient changes. In addition, the resistive force produced by the damping system 200 may be controlled by the design of the shape of the damping orifices 206, as is described below.

With reference now to FIGS. 2C and 2D, an associated area, e.g., the combined circumferential cross-sectional area between 206a and 206c, and consequently the shape of the flow paths 209, may be designed or configured to decrease as the piston 204 moves toward the proximal cylinder end 202a. In this case, progressively more force is required to move the piston 204 along the cylinder and progressively more and more energy is absorbed by the damping system 200 during a collision involving the object linked to the piston 204. This may result in a smaller flow path through which the hydraulic fluid can flow as the piston travels through the cylinder along the length of the damping orifice. As a result, the damping coefficient of the damping system 200 increases as the piston 204 moves within the cylinder 202. The damping orifices 206 may be semicircular in radial cross-section for ease of manufacturing and have a decreasing orifice depth along the length of the cylinder. Conversely, the combined circumferential cross-sectional area between 206a and 206c, and consequently the size of associated areas within the flow paths 209, may be designed or configured to increase as the piston 204 moves toward the proximal cylinder end 202a. In this situation, progressively less force is required to move the piston 204 along the cylinder and, correspondingly, progressively less and less energy is absorbed by the system 200 during a collision involving the object linked to the piston 204. In corresponding embodiments, the damping coefficient of the damping system 200 may decrease as the piston 204 moves within the cylinder 202.

Embodiments of the present invention including a cylinder and piston assembly having one or more damping orifices on the cylinder wall may be connected to or incorporated in a moving or stationary object to absorb impact energy and mitigate impact forces. In one example of a hydraulic force absorption system used in conjunction with a moving object, the cylinder may be connected to a frame of a vehicle, e.g., a car, while the piston may be connected by linkage to a bumper of the vehicle. In one example of a hydraulic force absorption system used in conjunction with a stationary object, the cylinder may be connected to a stationary object, such as barrier wall on a highway, a retaining wall, a building, or the like.

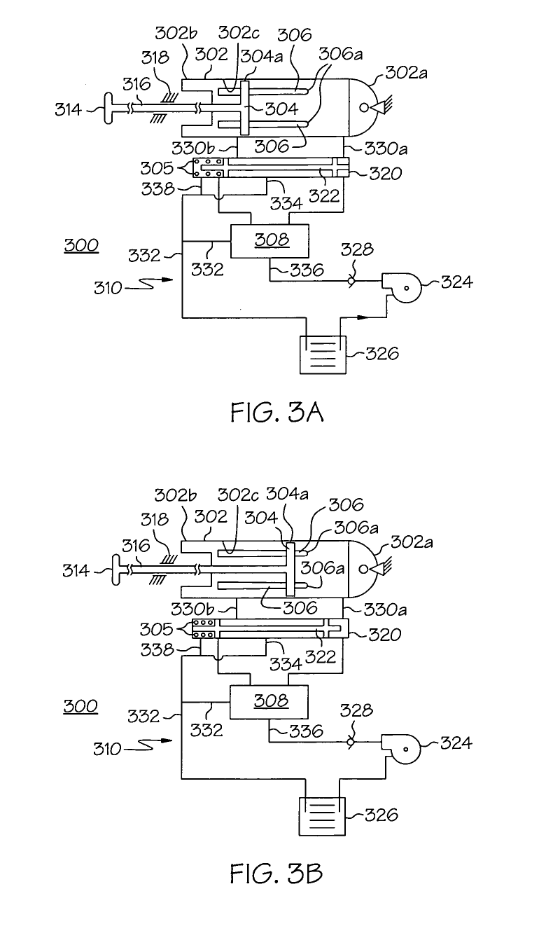

With reference now to FIG. 3, two schematic representations of an embodiment of a force absorption or damping system 300 are shown including a closed-loop control system and a cylinder and piston assembly. FIG. 3A and FIG. 3B show a piston 304 of a hydraulic actuator in an extend position and a retract position, respectively. In one embodiment this may correspond to a pre-accident position and a post-accident position, respectively. A cylinder 302 of the hydraulic actuator may have proximal cylinder end 302a, a distal cylinder end 302b, and an inner radial surface 302c defining a cylinder bore. The cylinder may be fixed at the proximal end 302a to an object or structure, e.g., a vehicle frame. Piston 304 slides within the cylinder bore of the cylinder 302 in response to forces produced by a hydraulic circuit 310 or forces imparted by objects outside of the damping system 300. The piston 304 has a piston sidewall or piston sidewall 304a that may have one or more seals to facilitate a hydraulic seal between the cylinder inner radial 302c surface and the piston 304.

The cylinder 302 of FIG. 3 may have one or more damping orifices 306 disposed on or in the inner radial wall 302c. Each damping orifice 306 may have an associated area, a circumferential cross-section 306a and a radial cross-section (not shown). A control valve 308 is shown connected to the cylinder 302 by a hydraulic circuit 310. The hydraulic circuit 310 may include two or more extend and retract lines 330a, 330b connected to the cylinder through ports (not shown). The hydraulic circuit 310, the control valve 308, and the cylinder 302 and piston 304, may operate together as part of a hydraulic servomechanism or proportional control device. The hydraulic servomechanism may operate to position the piston 304 within the cylinder 302. The control valve 308 may control the flow of hydraulic fluid to the cylinder 302 and piston 304, and may be an electric control valve (electrical connections for control valve 308 are omitted for the sake of clarity). An object, e.g., a bumper 314, may be connected to the piston 304 by linkage 316. A guide 318 may be present to constrain the movement and limit the degrees of freedom of the linkage 316 and any connected object, e.g., a bumper 314. A bypass valve 320 that allows initial movement of the piston 304 may be present within the hydraulic circuit 310 between the control valve 308 and the cylinder 302. The bypass valve 320 may be a shuttle valve having a shuttle piston 322. A spring 305 may be present within the shuttle valve to bias the position of the shuttle piston 322 in a desired direction, e.g., towards the right as shown in FIG. 3A. The hydraulic circuit 310 may also include a hydraulic pump 324 that operates to pressurize hydraulic fluid entering the cylinder 302. A hydraulic reservoir 326 and a check valve 328 to prevent hydraulic fluid flow back through the hydraulic pump 324 when a collision occurs may also be present in the hydraulic circuit 310.

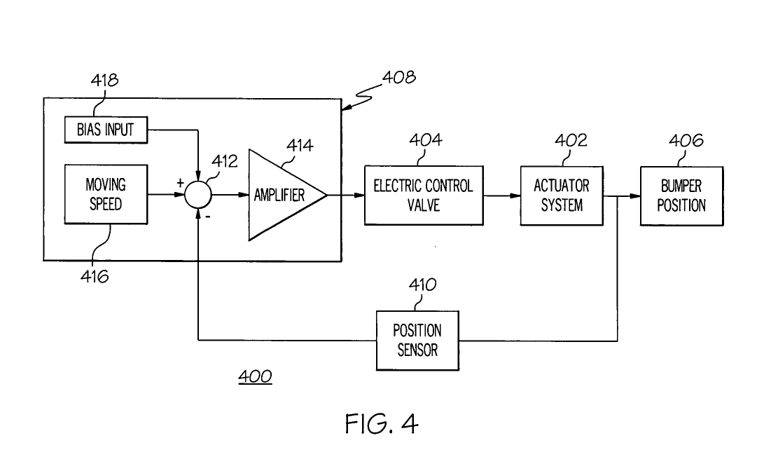

With continued reference to FIG. 3, the electric control valve 308 may function to position or locate the piston 302 at a particular location within the cylinder 304. In certain embodiments, the electric control valve may be a proportional control valve. In other embodiments, the electric control valve 308 may be an electro-hydraulic servovalve, e.g., a four-way electro-hydraulic servo, which pumps or apportions fluid to one side of the piston or the other. The electric control valve 308 may be a critical-center, open-center, or closed-center type electro-hydraulic control valve. The electric control valve 308 may also be controlled by a closed-loop control system that adjusts the distance that a vehicle bumper extends from a vehicle that is connected to the damping system 300, depending on the speed of the vehicle. In such embodiments, as the speed of the vehicle increases, so too does the pre-impact distance, i.e., the distance that the bumper extends relative to the vehicle prior to a collision or impact. The electric control valve 308 may receive a control signal from a controller such as an electrical control unit, described in greater detail below for FIG. 4.

In operation, hydraulic fluid is supplied to the cylinder 302 by the hydraulic circuit 310 in the damping system 300. The control valve 308 may control the supply of the hydraulic fluid to the cylinder. As shown in FIG. 3A, the hydraulic fluid may act on the piston 304, pushing the piston 304 to an extend position. Hydraulic fluid flows through line 330b to the control valve 308 and to a first return line 332. Spring 305 biases the bypass valve 320 to an open position as shown. When the object connected to the piston, e.g., bumper 314, is hit by another object, an impact energy and force may be transmitted along the linkage to the piston 304. When the impact force transmitted to the piston 304 exceeds the countering force produced by the hydraulic fluid in the hydraulic circuit 310, the piston 304 will move from the pre-impact position toward the proximal end of the cylinder 302a, as shown in FIG. 3B. The initial movement of the piston 304 causes an increased pressure in the hydraulic fluid in the cylinder 302. The increased pressure in turn closes the bypass valve 320, allowing the hydraulic fluid to be diverted from the proximal cylinder end 302a to the distal cylinder end 302b through damping orifice(s) 306 to a second return line 334 and then to the first return line 332. The control valve 308 and check valve 328 prevent flow of the hydraulic fluid in the hydraulic circuit through the supply line 336. An orifice line 338 may be present as shown to prevent cavitations or over-pressure in fluid, e.g., oil or hydraulic fluid, trapped in the shuttle valve 320. During the movement of the piston 304 in response to the impact, the one or more damping orifices 306 in the inner radial surface 302c allow hydraulic fluid to flow through the associated area(s) and around the piston 304. The velocity of the piston 304, and velocity of the object that is linked to it, are reduced or damped continuously by the hydraulic fluid flowing within the damping orifices 306.

Referring now to FIG. 4, a block diagram of a closed-loop control system 400 that may be used for automobile impact energy absorption and impact force damping is shown. The closed-loop control system 400 may include a hydraulic servomechanism including a cylinder and piston actuator assembly or actuator system 402 and an electric control valve 404. The closed-loop control system 400 may be incorporated into a vehicle (not shown). The piston of the actuator system 402 may be linked to a vehicle bumper that has a variable bumper position 406. An electronic control unit (ECU) 408 may produce an output control signal and may be connected to and control the electric control valve 404. The ECU 408 may be a stand-alone unit, integrated into the electronic control valve 404, or may be integrated into an electronic system of the vehicle. The ECU 408 may include a computer, microprocessor, or a field programmable gate array (FPGA), not shown, with necessary memory and input-output functionality. The ECU 408 may include a sum junction 412 or comparable device.

The sum junction 412 may include an amplifier 414 that increases the output control signal produced by the sum junction 412. The sum junction 412 may receive one or more inputs or signals from various sensors, which may be connected to the vehicle. For example, a speed sensor may send a signal to the ECU 408 indicating the moving speed of the vehicle 416. The sum junction 412 may receive signals from various other sensors sensing conditions such as a speed of an approaching object or vehicle, a weight of the vehicle, wheel spin rates of the wheels of the vehicle, and yaw, pitch, and roll conditions. The sum junction 412 may also receive a bias input 418. The bias input 418 may move the piston of the actuator system 402 an offset distance within the cylinder. For example, the bias input 418 may serve to move the piston and connected bumper a desired distance outward from the vehicle when a power system of the vehicle is activated. The bias input 418 may change polarity, e.g., to the negative, to move the piston to the retract position after parking the vehicle.

The closed-loop control system 400 may adjust the bumper position 406 relative to the vehicle by moving the piston of the actuator system 402 based on various signals received by the sum junction 412 in the ECU 408. For example, in response to receiving an increasing speed signal, the ECU 408 may send an output control signal to the control valve 404, which may cause the distance of the bumper position 406 to increase relative to the vehicle. Conversely, as the speed of the vehicle decreases, the closed-loop control system 400 may similarly retract the bumper thereby decreasing the distance the bumper extends from the vehicle. In this way, the closed-loop control system 400 may increase or decrease the distance over which damping orifices in an actuator system slow a piston during any impact with the bumper of the vehicle. As a result the closed-loop control system 400 may reduce the relative impact velocity and therefore kinetic energy between the vehicle and a colliding vehicle or object to safe levels.

With continued reference to FIG. 4, a closed-loop control system 400 according to one embodiment of the present invention has a characteristic system response time constant τ. The time constant τ may be influenced by load and impact conditions, as well as hydraulic system, and electrical/electronic system characteristics. In relation to the closed-loop control system 400, the time constant τ is a measure of how fast the ECU 408 can reposition the piston within the cylinder of the actuator system 402. It would be undesirable for the ECU 408 to retract the piston and consequently the bumper during an accident since doing so would reduce the range over which the piston velocity could be damped. Accordingly, in preferred embodiments, the time constant τ of the closed-loop control system 400 is designed to be significantly greater than the time that elapses during a typical accident, e.g., an automobile collision. A particular value of the time constant τ may be achieved or designed by selecting components of the closed-loop control system 400, e.g., by selecting appropriate inductance, resistance and capacitance values of the system 400 and/or the flow gain parameter of the electric control valve 404. By designing the control system 400 to have a time constant τ much greater than an impact time, the closed-loop control system 400 may be prevented from retracting the piston and bumper during an accident. Such a time constant τ helps to prevent the ECU 408 from prematurely retracting the bumper during the accident involving the vehicle. A time constant τ greater than the elapsed time of average accident conditions may be used. For example, the time constant τ may be one second, three seconds, five seconds, etc. The time constant τ may be varied for other known or anticipated impact conditions by the appropriate selection or design of hydraulic system and/or electrical/electronic system characteristics.

Use of an embodiment of the present invention will now be described in detail. A piston, which is slidingly disposed within a cylinder, is moved by hydraulic fluid to a pre-impact or extend position. One or more damping orifices are disposed on a wall of the cylinder. The position of the piston may vary or be controlled according to various conditions, such as the speed of a moving vehicle that is using the damping system or the speed of an oncoming vehicle. A servomechanism or a proportional control valve may be used to set or control the pre-impact position of the piston within the cylinder. When the object connected to the piston is displaced during an accident or collision, the piston may be forced from the pre-impact position along the bore of the cylinder and past the one or more damping orifices. Energy from the impact or collision is absorbed by the damping system as the hydraulic fluid in the hydraulic circuit is forced to flow through a flow path, including an associated area, formed by the one or more damping orifices and around the moving piston. Thus, the damping system can absorb impact energy and reduce impact velocities to safe levels for particular situations, e.g., for particular vehicles of a known mass, or for anticipated impact velocities.

Because the shape of the associated area and consequently the damping coefficient of the damping orifice can vary along the bore of the cylinder, the resistive force produced by systems and methods according to present invention may correspondingly vary. By designing the shapes of the damping orifices and associated areas, many damping coefficients can be achieved by the present invention, including continuously variable and nonlinear damping coefficients. These nonlinear damping coefficients may be desirable because they may produce different resistive forces or overall system responses to different impact or collision situations. The shape of the damping orifice may be such that (i) the circumferential cross-section increases, decreases, or remains constant from the distal cylinder end to the proximal cylinder end, and/or (ii) the radial cross-section increases, decreases, or remains constant from the distal cylinder end to the proximal cylinder end. In certain embodiments, the associated area of a damping orifice may increase or decrease from the distal cylinder end to the proximal cylinder end, producing a “falling-rate” or “rising-rate” damping coefficient, respectively. In certain embodiments, the damping orifice extends the entire length or substantially the entire length of the hydraulic cylinder. In exemplary embodiments, multiple damping orifices are present and are disposed at equiangular displacements on the inner radial wall of the cylinder to optimize symmetry of the hydraulic fluid flow and also to provide uniform heat dissipation.

Accordingly, embodiments of the present invention may reduce damage resulting from the collision between two or more objects. When embodiments are used in vehicles, vehicle damage and resulting occupant injury may be reduced. Furthermore, embodiments of the present invention may allow for more economical use of automobile structural frame material and consequently reduced structural mass. Such reduced mass may in turn produce reduced fuel consumption in the vehicles in which damping systems of the present invention are used. Embodiments may also be utilized in place of automobile airbags. Certain embodiments of the present damping system do not use mechanical springs and therefore do not generally contribute to oscillatory motion. Furthermore, some embodiments may have variable damping coefficients and produce varying resistive forces to collision objects. The damping coefficient may be nonlinear and may, therefore, produce a changing or variable system response, without the need for electrical feedback and associated circuitry. As a result, a force absorption system may have a desired type of nonlinear damping coefficient, and may offer a desired response, e.g., progressive or regressive, to particular collision situations, e.g., object mass, or velocity profile.

Although the present invention has been described in considerable detail with reference to certain versions thereof, other versions are possible. For example, while the shapes of the damping orifices have been described as generally circular or triangular in cross-section, one of skill in the art will understand that the scope of the present invention includes damping orifices of any cross-section shape. Additionally, while the description of embodiments of the present invention has been generally directed to single-acting actuators, the scope of present invention includes use of double-acting actuators or cylinder and piston assemblies. Those skilled in the art will understand that the present invention can be varied in many ways as will be apparent from the above description. The invention should therefore only be limited insofar as is required by the scope of the following claims.

The reader's attention is directed to all papers and documents that are filed concurrently with this specification and which are open to public inspection with this specification, and the contents of all such papers and documents are incorporated herein by reference. All the features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalents or similar features. Any element in a claim that does not explicitly state “means for” performing a specific function, is not to be interpreted as “means” or “step” clause as specified in 35 U.S.C. § 112, paragraph 6.

What is claimed is:

1. A cylinder and piston assembly comprising:
a cylinder;
a piston slidingly disposed within said cylinder; and
one or more damping orifices formed on an inner radial surface of said cylinder, wherein said damping orifices are configured to provide a fluid flow path with an associated area that varies as said piston travels within said cylinder past said one or more damping orifices.

2. The cylinder and piston assembly of claim 1, further comprising a hydraulic circuit in fluid communication with said piston, said hydraulic circuit being operational to supply pressurized hydraulic fluid to said piston.

3. The cylinder and piston assembly of claim 2, wherein said piston is movable in response to a force from an extend position to a retract position along a length of said cylinder by the force that is external to said cylinder and piston assembly.

4. The cylinder and piston assembly of claim 3, wherein said piston forces hydraulic fluid through said fluid flow path provided by said one or more damping orifices as said piston moves from said extend position to said retract position.

5. The cylinder and piston assembly of claim 4, wherein said hydraulic fluid absorbs energy as hydraulic fluid flows through said fluid flow path, and wherein a velocity of said piston is damped.

6. A hydraulic damping system comprising:
a cylinder, said cylinder having a proximal end, a distal, a cylinder bore defined by an inner radial surface, and a cylinder length;
one or more damping orifices disposed on said inner radial surface; and
a piston slidingly disposed within said cylinder bore, wherein said piston is movable from an extend position to a retract position along said cylinder length in response to a force external to said hydraulic damping system, and wherein said hydraulic damping system absorbs energy associated with a portion of said external force.

7. The hydraulic force absorption system of claim 6, further comprising a hydraulic circuit in fluid communication with said piston, said hydraulic circuit being operational to supply and receive pressurized hydraulic fluid to said cylinder by a supply line and a return line, wherein said piston forces hydraulic fluid through said one or more damping orifices as said piston moves from said extend position to said retract position.

8. The system of claim 6, wherein each of said one or more damping orifices has an associated area, a circumferential cross-section, a radial cross-section, an orifice length, an orifice width, and an orifice depth.

9. The system of claim 7, wherein said hydraulic circuit includes a hydraulic pump to pressurize said hydraulic fluid to an operational pressure.

10. The system of claim 8, wherein said orifice length of said one or more of said damping orifices is substantially equal to said cylinder length.

11. The system of claim 8, wherein said orifice length of said one or more of said damping orifices is equal to about a quarter of said cylinder length.

12. The system of claim 8, wherein said orifice length of said one or more of said damping orifices is equal to about one-third of said cylinder length.

13. The system of claim 8, wherein said orifice length of said one or more of said damping orifices is equal to about one-half of said cylinder length.

14. The system of claim 8, wherein said orifice length of said one or more of said damping orifices is equal to about two-thirds of said cylinder length.

15. The system of claim 8, wherein said orifice length of said one or more of said damping orifices is equal to about three-quarters of said cylinder length.

16. The system of claim 7, wherein said one or more damping orifices are positioned in said inner radial surface between a first port for said supply line and a second port for said return line.

17. A hydraulic damping system for collision energy absorption comprising:
a cylinder having a cylinder wall and a cylinder diameter, said cylinder having a first end and a second end, said cylinder having a first port and a second port;
a piston slidingly disposed within said cylinder, wherein said cylinder is linked to a vehicle;
at least one damping orifice disposed on said cylinder wall, each of said at least one damping orifice having an associated area, a circumferential cross-section, a radial cross-section, an orifice length, an orifice width, and an orifice depth, wherein said at least one damping orifice is configured to provide a fluid flow path in which said associated area varies as said piston travels within said cylinder past said at least one damping orifices;
a hydraulic circuit containing hydraulic fluid and operable to supply and receive hydraulic fluid from said first port and said second port, wherein said hydraulic circuit absorbs energy developed during a collision involving said vehicle as said piston moves relative to said at least one damping orifice; and
means for fluid displacement, wherein said means for fluid displacement enables said piston to move in said cylinder from a portion of said cylinder not including said at least one damping orifice to a portion of said cylinder including said at least one damping orifice and to displace hydraulic fluid within said circuit in response to a collision involving said vehicle, and wherein said piston slides past said at least one damping orifice within said cylinder during a collision.

18. The system of claim 17, further including a closed-loop control system comprising:
an electronic control unit operable to receive one or more signals from said vehicle and to produce an output control signal; and
an electric control valve operable to receive said output control signal, said electric control valve in fluid communication with said cylinder and piston and controlling an extend position of said piston.

19. The system of claim 18, wherein said closed-loop control system has a time constant greater than one second.

20. The system of claim 18, wherein said electronic control unit includes a sum junction.

21. The system of claim 20, wherein said sum junction is operable to receive one or more signals selected from the group consisting of a speed signal proportional to a speed of said vehicle from a speed sensor, a bias input, and a feedback position signal from a position sensor.

22. The systems of claim 21, wherein said electronic control unit further comprises an amplifier operable to receive and amplify said output control signal.

23. The systems of claim 21, wherein said feedback position signal indicates a position of a vehicle bumper connected to said vehicle.

24. The system of claim 21, wherein said output control signal decreases as said feedback position signal increases.

25. The systems of claim 21, wherein said output control signal increases as said speed signal increases.

26. The system of claim 18, wherein said electric control valve is an electro-hydraulic control valve.

27. The system of claim 26, wherein said electro-hydraulic control valve is selected from the group consisting of a critical-center, open-center, and closed-center type electro-hydraulic control valve.

28. The system of claim 26, wherein said electro-hydraulic control valve is a three-way or a four-way electro-hydraulic control valve.

29. The system of claim 18, wherein said electric control valve is a proportional control valve.

30. The system of claim 17, wherein said associated area of said at least one damping orifice decreases nonlinearly from said distal cylinder end to said proximal cylinder end.

31. The system of claim 17, wherein said associated area of said at least one damping orifice decreases from said distal cylinder end to said proximal cylinder end.

32. The system of claim 17, wherein said associated area of said at least one damping orifice increases nonlinearly from said distal cylinder end to said proximal cylinder end.

33. The system of claim 17, wherein said associated area of said at least one damping orifice increases from said distal cylinder end to said proximal cylinder end.

34. The system of claim 17, wherein said means for fluid displacement is a shuttle valve.

35. The system of claim 17, wherein said means for fluid displacement is a pressure-relief valve.

36. A method of manufacturing a hydraulic damping system comprising the step of:
forming one or more damping orifices on a hydraulic cylinder wall of a cylinder and piston assembly, wherein said one or more damping orifices are configured to provide a fluid flow path with an associated area that varies as said piston travels within said cylinder past said one or more damping orifices, wherein said hydraulic damping system is operable to absorb impact energy applied to said piston by said piston forcing fluid through said one or more flow paths.

37. The method of claim 36, further comprising the step of connecting said cylinder and piston assembly to a hydraulic circuit operable to supply said cylinder and piston assembly with pressurized hydraulic fluid.

38. The method of claim 36, further comprising the step of connecting said piston to a first portion of a vehicle and said cylinder to a second portion of said vehicle.

39. The method of claim 36, wherein said step of forming further comprises the step of pressing said hydraulic cylinder around a dummy piston to form said one or more damping orifices.

40. The method of claim 39, wherein said step of pressing includes pressing with hydrostatic pressure.

41. The method of claim 39, said step of forming further comprising attaching one or more wedges having a desired shape of a damping orifice to said dummy piston.

42. The method of claim 41, further comprising the step of forming a cylinder and piston assembly having one or more damping orifices disposed on an inner radial wall of said cylinder by placing a slidable piston in said cylinder.

43. The method of claim 41, further comprising the step of forming a cylinder and piston assembly having one or more damping orifices that provide a rising-rate damping coefficient to said hydraulic damping system.

44. The method of claim 41, further comprising the step of forming a cylinder and piston assembly having one or more damping orifices that provide a nonlinear rising-rate damping coefficient to said damping system.

45. The method of claim 41, further comprising the step of forming a cylinder and piston assembly having one or more damping orifices that provide a falling-rate damping coefficient to said hydraulic damping system.

46. The method of claim 41, further comprising the step of forming a cylinder and piston assembly having one or more damping orifices that provide a nonlinear falling-rate damping coefficient to said hydraulic damping system.

47. A method of absorbing impact energy and force comprising the steps of:
moving a piston along a cylinder bore past one or more damping orifices in response to an applied force, wherein said one or more damping orifices are configured to provide a fluid flow path that varies as said piston travels within said cylinder bore past said one or more damping orifices;
forcing hydraulic fluid through said one or more damping orifices with said piston, whereby impact energy and force are absorbed; and
damping the movement of said piston by a variable resistive force.

48. The method of claim 47, further comprising a step of controlling a final velocity of said piston at a post-impact position.

49. The method of claim 47, further comprising a step of adjusting a pre-impact position in response to a vehicle speed of a vehicle connected to said piston.

50. The method of claim 49, wherein said step of adjusting said pre-impact position includes adjusting said pre-impact position proportionally in response to said vehicle speed.

51. The method of claim 50, wherein said step of adjusting said pre-impact position is by a closed-loop control system including an electro-hydraulic control valve fluidly connected to said piston.

52. The method of claim 51, wherein said closed-loop control system has a time constant greater than one second.

53. A method of controlling a servomechanism used to absorb collision energy comprising the steps of:
adjusting a position of a piston of said servomechanism; and
preventing a retraction of said piston during a collision involving said piston by designing a time constant of said servomechanism to be greater than a time of said collision.

54. The method of claim 53, further comprising the step of forcing hydraulic fluid through one or more damping orifices in a cylinder wall of said servomechanism in response to said collision.

55. The method of claim 53, wherein said step of adjusting further comprises receiving one or more signals from a vehicle connected to said servomechanism.
